(19) United States
(12) Patent Application Publication
(10) Pub. No.: US 2005/0183076 A1
(43) Pub. Date: Aug. 18, 2005

(54) Browser-independent pop-up windows

(76) Inventors: Agatha Colangelo, Ontario (CA); Lee Anne Kowalski, Cupertino, CA (US); Nikolaj O. Richers, British Columbia (CA); David A. Sky, Ontario (CA)

Correspondence Address: IBM CORPORATION;INTELLECTUAL PROPERTY LAW, 11400 BURNET ROAD, AUSTIN, TX, 78758, US

(21) Appl. No.: 10/507,052

(22) PCT Filed: Apr. 15, 2003
(86) PCT No.: PCT/GB03/01616

(30) Foreign Application Priority Data
Apr. 29, 2002 (CA) 2384183

(51) Int. Cl. G06F 9/45; G06F 9/44

(52) U.S. Cl. 717/147; 717/162; 717/115

(57) ABSTRACT

A development tool for generating interactive help windows from SGML or XML definition files. The development tool supports the use of a defined keyword in link definitions in the definition files. The development tool adding a JavaScript function definition to an output HTML file, the function generating a new window having content defined by a file specified by a parameter for the function. The development tool replacing the link definitions including the defined keyword with calls to the JavaScript function. The development tool generating a pop-up definition HTML file having window content based on an SGML or XML definition provided to the development tool. The calls to the JavaScript function being defined in the HTML output file to pass the name of the pop-up definition HTML file as a parameter.

### FIELD OF THE INVENTION

The present invention is directed to an improvement in computing systems and in particular to an improvement in defining browser-independent pop-up windows.

### BACKGROUND OF THE INVENTION

In computer program products it is common to include interactive help components. Such components permit users to access help windows that contain reference and-other help information that will answer user questions or guide a user through various aspects of the operation of the computer program products. In some cases such interactive help systems incorporate pop-up windows. These are displayed on the user's screen on request as the user navigates through the interactive help system. Rather than a single window, in which different information is sequentially displayed, a pop-up window is typically a separate window that partially overlays the window from which the pop-up is invoked. Typically, a first help window remains in place and a second, often smaller, window pops up over the first one.

Pop-up windows are particularly useful where a detail of a larger system is explained, or where a wizard or other guiding help system is used to take a user through different steps in a process.

Typically, such pop-up windows are defined and generated using proprietary help or guidance systems that are intended for use with a particular defined product, or family of products. Content for such systems is written for the appropriate products and platforms that the proprietary systems are designed to work with. Generating and maintaining multiple versions of similar interactive help systems is required and is often duplicitous and inefficient.

Given the continuing need for documentation, including manuals, users' guides, and interactive help facilities, standardized development tools have been developed. Such tools assist developers in creating different documentation and help materials by streamlining and guiding the creation process. The proprietary nature of interactive help systems makes it difficult for such standardized development tools to generate content having a format compatible with the particular interactive help system with which a developer may be working.

It is therefore desirable to have a method and system for developing pop-up windows, where the development and operation of such pop-up windows is not closely tied to a particular computer product, or family of products.

### SUMMARY OF THE INVENTION

According to an aspect of the present invention there is provided an improved method and system for providing browser-independent pop-up windows.

According to another aspect of the present invention there is provided a computer program product for use with a development tool, typically as a post-processor or as part of the development tool itself. The computer program product generates browser-readable code, such as HTML code, that contains a routine for displaying a pop-up window. This code reflects an SGML or XML definition provided to the development tool. The definition includes a link definition with a form to indicate that the link definition refers to a pop-up window. The browser-readable code includes an invocation of the routine that will cause the routine to display the pop-up window.

According to another aspect of the present invention there is provided a computer program product for generating pop-up windows for a computer system, the program product including a computer usable medium tangibly embodying computer readable program code means for implementation in combination with a development tool, the development tool accepting a set of definition files having a format selected from SGML format or XML format, the definition files including a link definition file and a content definition file, the computer readable program code means including code means for generating an HTML content file based on the content definition file, the HTML content file having a pop-up content file name, code means for identifying a pop-up link definition including a defined keyword, initially contained in the link definition file, code means for generating an HTML output file, the HTML output file being based on the link definition file and including a JavaScript function definition, the JavaScript function definition including code for opening a pop-up window to display content derived from an HTML file specified by an identified parameter, and HTML code corresponding to the pop-up link definition and including a call to the JavaScript function with the pop-up content file name as the identified parameter.

According to another aspect of the present invention there is provided the above computer program product in which the computer readable program code means includes a post-processor, the development tool including means for generating a first intermediate HTML file based on the content definition file and a second intermediate HTML file based on the link definition file, the development tool passing the pop-up link definition from the link definition file to the second intermediate HTML file, the post-processor including code means for accepting the intermediate HTML files as input.

According to another aspect of the present invention there is provided the above computer program product in which the code means for identifying a pop-up link definition including a defined keyword includes code means for scanning the second intermediate HTML file to locate the defined keyword.

According to another aspect of the present invention there is provided the above computer program product in which the computer readable program code means is implemented within the development tool.

According to another aspect of the present invention there is provided a computer program product for generating pop-up windows for a computer system, each pop-up window being defined by a content definition being addressable by a pop-up content name, the program product including a computer usable medium tangibly embodying computer readable program code means for implementation in combination with a development tool, the development tool accepting a set of input definition data having a format selected from SGML or XML, the input definition data including link definition data and content definition data and including code means for identifying a pop-up specifier including a defined indicia, initially contained in the link definition data, code means for generating browser-readable link code based on the link definition data and including invocable code for opening a pop-up window to display content derived from a selected content definition specified by an associated identifier, and browser-readable code corresponding to the pop-up specifier and including an invocation of the invocable code such that the associated identifier is defined with reference to the pop-up content name for addressing the selected content definition.

According to another aspect of the present invention there is provided the above computer program product in which the browser-readable code is HTML code.

According to another aspect of the present invention there is provided the above computer program product in which the invocable code is an invocable routine and the associated identifier is a parameter for the routine.

According to another aspect of the present invention there is provided a computer-implemented method for generating pop-up windows for a computer system, the method including accepting a set of definition files having a format selected from SGML format or XML format, the definition files including a link definition file and a content definition file, generating an HTML content file based on the content definition file, the HTML content file having a pop-up content file name, identifying a pop-up link definition including a defined keyword, initially contained in the link definition file, and generating an HTML output file, the HTML output file being based on the link definition file and including a JavaScript function definition, the JavaScript function definition including code for opening a pop-up window to display content derived from an HTML file specified by an identified parameter, and HTML code corresponding to the pop-up link definition and including a call to the JavaScript function with the pop-up content file name as the identified parameter.

According to another aspect of the present invention there is provided the above method further including, after accepting the set of definition files generating a first intermediate HTML file based on the content definition file and a second intermediate HTML file based on the link definition file; and passing the pop-up link definition from the link definition file to the second intermediate HTML file, and in which the step of generating an HTML content file includes the step of accepting the first intermediate HTML file as input to generate the HTML content file, and the step of generating an HTML output file includes the step of accepting the second intermediate HTML file as input and processing that file to generate the HTML output file.

According to another aspect of the present invention there is provided the above method for generating pop-up windows for a computer system, each pop-up window being defined by a content definition being addressable by a pop-up content name, the method including accepting link definition data having a format selected from SGML or XML and generating output data in browser-readable format, identifying a pop-up specifier including a defined indicia, initially contained in the link definition data, and generating browser-readable link code based on the link definition data and including invocable code for opening a pop-up window to display content derived from a selected content definition specified by an associated identifier, and browser-readable code corresponding to the pop-up specifier and including an invocation of the invocable code such that the associated identifier is defined with reference to the pop-up content name for addressing the selected content definition.

According to another aspect of the present invention there is provided the above method further including the steps of, after accepting the set of definition files generating intermediate browser-readable data based on the link definition data, and passing the pop-up link definition from the link definition data to the intermediate browser-readable data, and in which the step of generating browser-readable link code includes the step of accepting the intermediate browser-readable data as input and processing that data to generate the browser-readable output data.

According to another aspect of the present invention, there is provided a method for generating a pop-up window, the method including accepting a set of definition files having a format selected from a multiplicity of computer mark-up language formats, the definition files including a link definition file and a content definition file; generating a display language content file based on the content definition file, the display language content file having a pop-up content file name; identifying a pup-up link definition including a defined keyword, initially contained in the link definition file; generating a display language output file based on the link definition file, the display language output file including: a function definition including code for opening a pop-up window to display content derived from a display language file specified by an identified parameter; and a display language code corresponding to the pop-up link definition and including a call to the function with the pop-up content file name as the identified parameter.

Advantages of the present invention include a method and system that permit uniform definition of pop-up windows for display using different browsers. When used in conjunction with a development tool useable for defining documentation and help systems, the invention permits a single set of content definitions to be used to generate different forms of output, including information to be displayed in the pop-up windows in interactive help sessions.

### BRIEF DESCRIPTION OF THE DRAWINGS

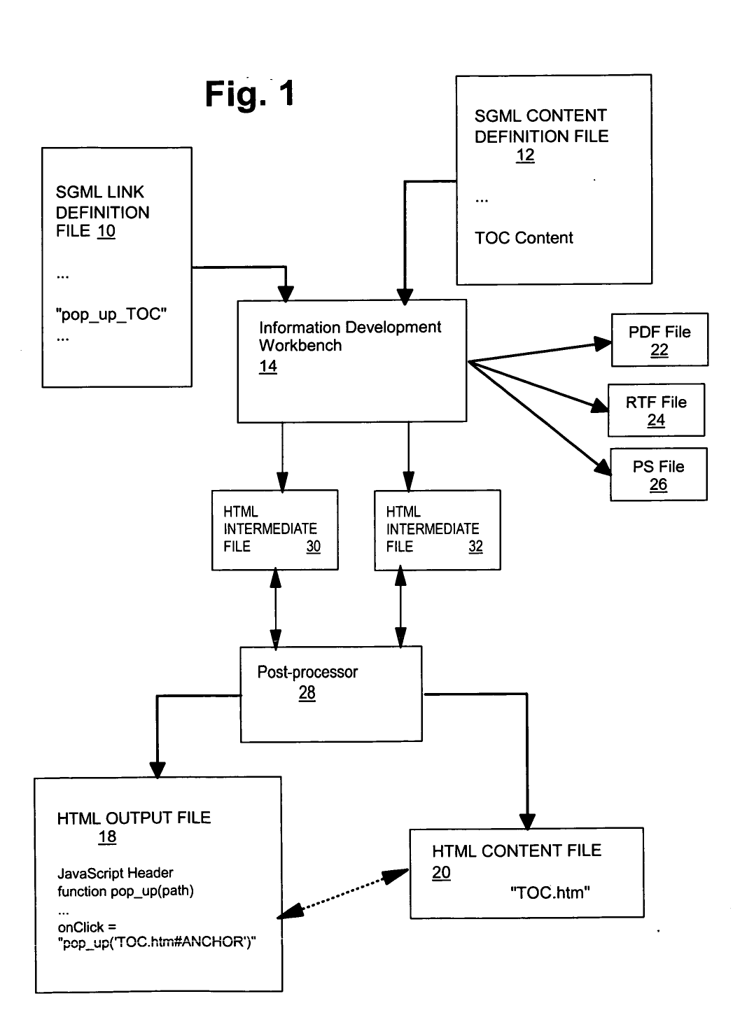

The preferred embodiment of the invention is shown in the drawings, wherein FIG. 1 is a block diagram illustrating components in an example showing the definition of pop-up windows in accordance with the preferred embodiment.

In the drawings, the preferred embodiment of the invention is illustrated by way of example. It is to be expressly understood that the description and drawings are only for the purpose of illustration and as an aid to understanding, and are not intended as a definition of the limits of the invention.

### DETAILED DESCRIPTION OF THE PREFERRED EMBODIMENT

FIG. 1 is a block diagram illustrating components in an example system for the definition of pop-up windows in accordance with the preferred embodiment.

The preferred embodiment is described with reference to the Information Development Workbench (IDWB) development tool of International Business Machines Corporation. Although the description refers to this particular product, it will be understood by those skilled in the art that the preferred embodiment may be implemented with respect to other development tools having similar functionality. The IDWB tool takes content definition files and generates, in response to user specifications, one or more output files having a defined format and content reflecting the content definition files.

In the preferred embodiment, the contents and structure of documentation and help facility screens generated by the IDWB tool are defined by one or more SGML (Structured Generalized Markup Language) files. Alternatively, XML (Extensible Markup Language) files may be used to define the content. As will be apparent to those skilled in the art, the approach of the preferred embodiment may be implemented for either XML or SGML files with the appropriate changes to the processing steps carried out to generate the HTML output files having the characteristics described. Two example SGML files 10, 12 are shown in FIG. 1 as defining input for IDWB tool 14. As will be appreciated, IDWB 14 permits a developer to use a single set of SGML or XML files to define interactive help system pages, paper documentation, or other online documentation.

To accomplish this, IDWB 14 selectively produces output files in a user-specified format chosen from several possibilities. FIG. 1 includes representations of a number of these possibilities:
a) HTML (HyperText Markup Language) output file 18 and HTML content file 20; such HTML files are used in generating interactive help windows, as described in more detail below;
b) PDF (Postscript Display File) file 22, used for the generation of user manuals and other printed material, as well as electronically accessible documentation;
c) RTF (Rich Text Format) file 24, used for the generation of files to be accessed by readers such as common word processing programs; and
d) PS (Postscript) file 26, used for printer-ready materials.

The generation of popup windows by the preferred embodiment is described with reference to example HTML output file 18 and HTML content file 20. In the example of FIG. 1, post-processor 28 is shown which takes HTML file output from IDWB 14 (shown as HTML intermediate files 30, 32 ). In the arrangement of the preferred embodiment shown in FIG. 1, post-processor 28 accepts HTML file output from IDWB 14 as input. In this sense, the HTML intermediate files 30, 32 produced by IDWB 14 (as shown in FIG. 1) are intermediate files. Post-processor 28 carries out defined steps on intermediate HTML files 30, 32 and produces HTML format files (files 18, 20 in FIG. 1). The HTML files generated by IDWB 14 correspond to SGML input files. Alternatively, HTML content file 20 may be generated without the use of IDWB 14 (and without the requirement for the pop-up window content to be initially defined by an SGML or XML definition file). In such a case, the file name for HTML content file 20 will be provided to post-processor 28 to permit the file to be referenced by HTML output file 18, as described below.

As it will be appreciated, the functionality of post-processor 28 may also be incorporated within IDWB 14 or an equivalent development tool. When this is the case, HTML intermediate files 30, 32 may not necessarily be produced as a development tool incorporating the functionality of post-processor 27 may generate the final form of HTML files (files 18, 20 in the example of FIG. 1), directly. Whether the preferred embodiment is implemented as a post-processor or as an integral part of a development tool, it will be understood that the preferred embodiment is intended to be implemented in combination with such a development tool. It will be further appreciated that although the description refers to files, the definition data for the link definition and the pop-up content definition may be maintained in a format other than a file format. In addition, it should be noted that the preferred embodiment describes the use of HTML format data as this provides a browser-readable format for the pop-up windows. Other browser-readable formats may also be generated by the development tool and such formats may be used in other implementations of the preferred embodiment.

According to the preferred embodiment, when pop-up windows are required, a predefined keyword prefix is included in the appropriate locations in the SGML files that are inputs for IDWB 14. Such files may be referred to as “link definition files” as they contain references to other files or window contents definitions, often expressed as links. It will be appreciated that the use of a keyword is described in the preferred embodiment but other indicia may be selected to be used in the place of a keyword.

In the preferred embodiment configuration shown in FIG. 1, any prefix keywords in the link definition files are passed through IDWB 14 and retained in the HTML intermediate files generated by the development tool. Post-processor 28 parses the HTML intermediate files to locate the keyword or keywords. Post-processor 28, in response to locating the keyword prefix in particular link statements in the HTML intermediate files, includes certain code in HTML output files, as described below. The resultant HTML files are therefore based on the HTML intermediate file content received by post-processor 28 and on the keyword prefixes located by the post-processor.

In the preferred embodiment described, “popup_” is used as the keyword prefix. The design of the preferred embodiment permits other keywords or indicia to be used to trigger the post-processor to make the appropriate code insertions in the resultant HTML files. Alternatively, multiple keywords may be given different significances by the system of the preferred embodiment. For example, different pop-up window dimensions may be specified using different keywords in the SGML content-defining files. Similarly, different mechanisms for identifying the HTML file that specifies the content of a pop-up window may be indicated using different keywords. Where an implementation does not utilize SGML or XML definition files it will be understood that a pop-up specifier having a defined format (and being analogous to a link statement in the SGML or XML files) will be included in the link definition data, and that the pop-up specifier will contain an indicia used to identify the pop-up specifier as such.

An example of SGML code having a prefix keyword, as described above, is the following SGML code:

<L LINKEND=“popup_TOC_admin_guide”>Administration
Guide</L>.

As can be seen, the SGML-format file specification of the interactive help system incorporating the pop-up window does not require a special syntax. The defined keyword prefix is used as part of the SGML L LINKEND definition. The SGML code is transformed into the corresponding HTML pages by IDWB 14 in the preferred embodiment. The term “popup_TOC_admin_guide” passes through IDWB 14 to post-processor 28. The steps taken by post-processor 28 are described below, with reference to the example of FIG. 1.

In FIG. 1, SGML link definition file 10 is shown with an SGML code fragment containing “popup_TOC”. The use of the “popup_” prefix in file 10 defines the link in a first window that will be available to the user in the interactive help system (by the related HTML page definition). When the user invokes the interactive help system, the link can be selected by the user to cause a pop-up window to be displayed.

The inclusion of the “popup_” prefix in file 10 requires the content of the pop-up window to be defined. In the preferred embodiment, this is provided by a related SGML content definition file. In the example of FIG. 1, SGML content definition file 12 contains this definition of pop-up window content. Both SGML link definition file 10 and SGML content definition file 12 are used as input for IDWB 14. IDWB 14 generates HTML files based on these SGML files. In operation, post-processor 28 scans the intermediate HTML file corresponding to SGML link definition file 10 for keyword prefixes specifying a pop-up. As indicated above, in the example of FIG. I and the preferred embodiment, the prefix is “popup_”. A post-processing script scans the HTML intermediate file to locate the keyword that identifies a link as a pop-up. Where such a keyword is identified, the link definition in the HTML output file is modified to include a call to a defined JavaScript function that the post-processing component (post-processor 28 ) includes in the HTML output file.

An example of such a JavaScript function is given as follows:

```
function pop_up(path) {
    var parameters = “left=” + (screen.width/2) +
”top=50,toolbar=no,menubar=no,status=no,scrollbars=yes,resizable=yes
,width=” + ((screen.width/2)−50) + “,height=” + (screen.height−200)
+ “”;
    newWindow = window.open(path,‘name’,parameters);
    return true;
} //end pop-up
```

The post-processing script will replace an existing link definition (containing the keyword prefix) in the HTML intermediate file with HTML code referencing the JavaScript function. The parameter passed to the JavaScript function is a file name containing the HTML page to be displayed in the pop-up window. In the example of FIG. 1, the call to the JavaScript function popup is “popup(‘TOC.htm#ANCHOR’)”. HTML content file 20 has file name “TOC.htm” in the example.

As referred to above, in the example of FIG. 1, SGML content definition file 12 contains content code defining the content for the new (pop-up) window. SGML content definition file 12 is processed by IDWB 14 and post-processor 28 to produce HTML content file 20, the file that defines the pop-up window content. Post-processor 28 parses the SGML code containing the popup_ prefix to generate the HTML code for HTML output file 18 such that it references the HTML file having the TOC content information contained in it (TOC.htm in the example of FIG. 1).

As a result of the definition of the SGML link definition file 10 and SGML content definition file 12 and the operation of post-processor 28, HTML output file 18 having a JavaScript pop-up function definition similar to that set out above is generated. A link defined in the HTML output with the pop-up prefix will result in a call to the JavaScript function which will in turn result in the display of an HTML page as defined by the file indicated in the parameter for the pop-up function call.

As can be seen from the above, the preferred embodiment provides a simple mechanism for including definitions of pop-up windows in an SGML file definition used for document and help system creation. A pop-up window definition may be defined in a straightforward manner, differing from a standard link by the inclusion of a defined keyword. Post-processor 28 provides for a HTML file output including functionality to permit the pop-up window to be displayed when appropriate. As will be appreciated, the inclusion of this functionality in standard HTML code permits the help system, including the pop-up windows, to be used by any HTML browser, which provides the system with platform independence.

Although a preferred embodiment of the present invention has been described here in detail, it will be appreciated by those skilled in the art that other variations may be made. For example, the SGML or XML definitions used as inputs for the development tool may be in form other than files. Such variations may be made without departing from the spirit of the invention or the scope of the appended claims.

1-45. (canceled)

46. A computer program product for generating pop-up windows for a computer system, the program product comprising a computer usable medium tangibly embodying computer readable program code means for implementation in combination with a development tool, the development tool accepting a set of definition files having a format selected from SGML format or XML format, the definition files comprising a link definition file and a content definition file, the computer readable program code means comprising:
code means for generating an HTML content file based on the content definition file, the HTML content file having a pop-up content file name,
code means for identifying a pop-up link definition including a defined keyword, initially contained in the link definition file,
code means for generating an HTML output file, the HTML output file being based on the link definition file and comprising
a JavaScript function definition, the JavaScript function definition comprising code for opening a pop-up window to display content derived from an HTML file specified by an identified parameter, and
HTML code corresponding to the pop-up link definition and comprising a call to the JavaScript function with the pop-up content file name as the identified parameter.

47. The computer program product of claim 46 in which the computer readable program code means comprises a post-processor, the development tool comprising means for generating a first intermediate HTML file based on the content definition file and a second intermediate HTML file based on the link definition file, the development tool passing the pop-up link definition from the link definition file to the second intermediate HTML file, the post-processor comprising code means for accepting the intermediate HTML files as input.

48. The computer program product of claim 47 in which the code means for identifying a pop-up link definition including a defined keyword comprises code means for scanning the second intermediate HTML file to locate the defined keyword.

49. The computer program product of claim 46 in which the computer readable program code means is implemented within the development tool.

50. A computer program product for generating pop-up windows for a computer system, each pop-up window being defined by an HTML content file having a pop-up content file name, the program product comprising a computer usable medium tangibly embodying computer readable program code means for implementation in combination with a development tool, the development tool accepting a set of definition files having a format selected from SGML format or XML format, the definition files comprising a link definition file and a content definition file, the computer readable program code means comprising:
code means for identifying a pop-up link definition including a defined keyword, initially contained in the link definition file, and referring to a selected HTML content file,
code means for generating an HTML output file, the HTML output file being based on the link definition file and comprising
a JavaScript function definition, the JavaScript function definition comprising code for opening a pop-up window to display content derived from an HTML file specified by an identified parameter, and
HTML code corresponding to the pop-up link definition and comprising a call to the JavaScript function with the pop-up content file name of the selected HTML content file as the identified parameter.

51. The computer program product of claim 50 in which the computer readable program code means comprises a post-processor, the development tool comprising means for generating an intermediate HTML file based on the link definition file, the development tool passing the pop-up link definition from the link definition file to the intermediate HTML file, the post-processor accepting the intermediate HTML file as input.

52. The computer program product of claim 51 in which the code means for identifying a pop-up link definition including a defined keyword comprises code means for scanning the intermediate HTML file to locate the defined keyword.

53. The computer program product of claim 50 in which the computer readable program code means is implemented within the development tool.

54. A computer program product for generating pop-up windows for a computer system, the program product comprising a computer usable medium tangibly embodying computer readable program code means for implementation in combination with a development tool, the development tool accepting a set of definition files having a format selected from SGML format or XML format, the definition files comprising a link definition file and a content definition file, the computer readable program code means comprising:
code means for generating an HTML content file based on the content definition file, the HTML content file having a pop-up content file name,
code means for identifying a pop-up link definition including a defined keyword in a set of defined keywords, each one of the set of defined keywords corresponding to one of a set of defined JavaScript function definitions, the pop-up link definition initially being contained in the link definition file,
code means for generating an HTML output file, the HTML output file being based on the link definition file and comprising
a definition of a selected one of the set of JavaScript functions, the selected JavaScript function definition comprising code for opening a pop-up window to display content derived from an HTML file specified by an identified parameter, the selected JavaScript function corresponding to the keyword included in the pop-up link definition, and
HTML code corresponding to the pop-up link definition comprising a call to the selected JavaScript function with the pop-up content file name as the identified parameter.

55. The computer program product of claim 54 in which the computer readable program code means comprises a post-processor, the development tool comprising means for generating a first intermediate HTML file based on the content definition file and a second intermediate HTML file based on the link definition file, the development tool passing the pop-up link definition from the link definition file to the second intermediate HTML file, and the post-processor comprising code means for accepting the intermediate HTML files as input.

56. The computer program product of claim 55 in which the code means for identifying a pop-up link definition including a defined keyword in the set of defined keywords comprises code means for scanning the second intermediate HTML file to locate any one of the set of defined keywords.

57. The computer program product of claim 54 in which the computer readable program code means is implemented within the development tool.

58. A computer program product for generating pop-up windows for a computer system, the program product comprising a computer usable medium tangibly embodying computer readable program code means for implementation in combination with a development tool, the development tool accepting a set of input definition data having a format selected from SGML or XML, the input definition data comprising link definition data and content definition data, the computer readable program code means comprising:
code means for generating browser-readable content code based on the content definition data, the browser-readable content code being addressable by a pop-up content name,
code means for identifying a pop-up specifier including a defined indicia, initially contained in the link definition data,
code means for generating browser-readable link code based on the link definition data and comprising
invocable code for opening a pop-up window to display content derived from an browser-readable content definition, the browser-readable content definition being specified by an associated identifier, and
browser-readable code corresponding to the pop-up specifier and comprising an invocation of the invocable code such that the associated identifier is defined with reference to the pop-up content name.

59. The computer program product of claim 58 in which the browser-readable code is HTML code.

60. The computer program product of claim 58 in which the invocable code is an invocable routine and the associated identifier is a parameter for the routine.

61. The computer program product of claim 58 in which the computer readable program code means comprises a post-processor, the development tool comprising means for generating first intermediate browser-readable data based on the content definition data and second intermediate browser-readable data based on the link definition data, the development tool passing the pop-up link definition from the link definition data to the second intermediate browser-readable data, the post-processor comprising code means for accepting the intermediate browser-readable data as input.

62. The computer program product of claim 61 in which the code means for identifying a pop-up specifier including a defined indicia comprises code means for scanning the second intermediate browser-readable data to locate the defined indicia.

63. The computer program product of claim 58 in which the computer readable program code means is implemented within the development tool.

64. A computer program product for generating pop-up windows for a computer system, each pop-up window being defined by a content definition being addressable by a pop-up content name, the program product comprising a computer usable medium tangibly embodying computer readable program code means for implementation in combination with a development tool, the development tool accepting a set of input definition data having a format selected from SGML or XML, the input definition data comprising link definition data and content definition data and comprising:
code means for identifying a pop-up specifier including a defined indicia, initially contained in the link definition data,
code means for generating browser-readable link code based on the link definition data and comprising
invocable code for opening a pop-up window to display content derived from a selected content definition specified by an associated identifier, and
browser-readable code corresponding to the pop-up specifier and comprising an invocation of the invocable code such that the associated identifier is defined with reference to the pop-up content name for addressing the selected content definition.

65. The computer program product of claim 64 in which the browser-readable code is HTML code.

66. The computer program product of claim 64 in which the invocable code is an invocable routine and the associated identifier is a parameter for the routine.

67. The computer program product of claim 64 in which the computer readable program code means comprises a post-processor, the development tool comprising means for generating intermediate browser-readable data based on the link definition data, the development tool passing the pop-up link definition from the link definition data to the intermediate browser-readable data, the post-processor accepting the intermediate browser-readable data as input.

68. The computer program product of claim 67 in which the code means for identifying a pop-up specifier including a defined indicia comprises code means for scanning the intermediate browser-readable data to locate the defined indicia.

69. The computer program product of claim 64 in which the computer readable program code means is implemented within the development tool.

70. A computer-implemented method for generating pop-up windows for a computer system, the method comprising:
accepting a set of definition files having a format selected from SGML format or XML format, the definition files comprising a link definition file and a content definition file,
generating an HTML content file based on the content definition file, the HTML content file having a pop-up content file name,
identifying a pop-up link definition including a defined keyword, initially contained in the link definition file, and
generating an HTML output file, the HTML output file being based on the link definition file and comprising
a JavaScript function definition, the JavaScript function definition comprising code for opening a pop-up window to display content derived from an HTML file specified by an identified parameter, and
HTML code corresponding to the pop-up link definition and comprising a call to the JavaScript function with the pop-up content file name as the identified parameter.

71. The method of claim 70 further comprising the steps of, after accepting the set of definition files:
generating a first intermediate HTML file based on the content definition file and a second intermediate HTML file based on the link definition file, and
passing the pop-up link definition from the link definition file to the second intermediate HTML file,
and in which the step of generating an HTML content file comprises the step of accepting the first intermediate HTML file as input to generate the HTML content file, and the step of generating an HTML output file comprises the step of accepting the second intermediate HTML file as input and processing that file to generate the HTML output file.

72. The method of claim 71 in which the step of identifying a pop-up link definition including a defined keyword comprises the step of scanning the second intermediate HTML file to locate the defined keyword.

73. A computer-implemented method for generating pop-up windows for a computer system, each pop-up window being defined by an HTML content file having a pop-up content file name, the method comprising:
accepting a link definition file having a format selected from SGML format or XML format,
identifying a pop-up link definition including a defined keyword, initially contained in the link definition file, and referring to a selected HTML content file,
generating an HTML output file, the HTML output file being based on the link definition file and comprising
a JavaScript function definition, the JavaScript function definition comprising code for opening a pop-up window to display content derived from an HTML file specified by an identified parameter, and
HTML code corresponding to the pop-up link definition and comprising a call to the JavaScript function with the pop-up content file name of the selected HTML content file as the identified parameter.

74. The method of claim 73 further comprising the steps of, after accepting the set of definition files:
generating an intermediate HTML file based on the link definition file, and
passing the pop-up link definition from the link definition file to the intermediate HTML file,
and in which the step of generating an HTML output file comprises the step of accepting the second intermediate HTML file as input and processing that file to generate the HTML output file.

75. The method of claim 74 in which the step of identifying a pop-up link definition including a defined keyword comprises the step of scanning the intermediate HTML file to locate the defined keyword.

76. A computer-implemented method for generating pop-up windows for a computer system, the method comprising:
accepting a set of input definition data having a format selected from SGML or XML, the input definition data comprising link definition data and content definition data,
generating browser-readable content code based on the content definition data, the browser-readable content code being addressable by a pop-up content name,
identifying a pop-up specifier including a defined indicia, initially contained in the link definition data, and
generating browser-readable link code based on the link definition data and comprising
invocable code for opening a pop-up window to display content derived from an browser-readable content definition, the browser-readable content definition being specified by an associated identifier, and
browser-readable code corresponding to the pop-up specifier and comprising an invocation of the invocable code such that the associated identifier is defined with reference to the pop-up content name.

77. The method of claim 76 further comprising the steps of, after accepting the set of definition files:
generating first intermediate browser-readable data based on the content definition data and second intermediate browser-readable data based on the link definition data, and
passing the pop-up link definition from the link definition data to the second intermediate browser-readable data,
and in which the step of generating browser-readable content code comprises the step of accepting the first intermediate browser-readable data as input and processing that data to generate the browser-readable content code, and in which the step of generating browser-readable link code comprises the step of accepting the second intermediate browser-readable data as input and processing that file to generate the browser-readable link code.

78. The method of claim 77 in which the step of identifying a pop-up specifier including a defined indicia comprises the step of scanning the second intermediate browser-readable data to locate the defined indicia.

79. A computer-implemented method for generating pop-up windows for a computer system, each pop-up window being defined by a content definition being addressable by a pop-up content name, the method comprising:
accepting link definition data having a format selected from SGML or XML and generating output data in browser-readable format,
identifying a pop-up specifier including a defined indicia, initially contained in the link definition data, and
generating browser-readable link code based on the link definition data and comprising
invocable code for opening a pop-up window to display content derived from a selected content definition specified by an associated identifier, and
browser-readable code corresponding to the pop-up specifier and comprising an invocation of the invocable code such that the associated identifier is defined with reference to the pop-up content name for addressing the selected content definition.

80. The method of claim 79 further comprising the steps of, after accepting the set of definition files:
generating intermediate browser-readable data based on the link definition data, and,
passing the pop-up link definition from the link definition data to the intermediate browser-readable data,
and in which the step of generating browser-readable link code comprises the step of accepting the intermediate browser-readable data as input and processing that data to generate the browser-readable output data.

81. The method of claim 80 in which the step of identifying a pop-up specifier including a defined indicia comprises the step of scanning the intermediate browser-readable data to locate the defined indicia.

82. A method for generating a pop-up window, the method including:
accepting a set of definition files having a format selected from a multiplicity of computer mark-up language formats, the definition files including a link definition file and a content definition file;
generating a display language content file based on the content definition file, the display language content file having a pop-up content file name;
identifying a pup-up link definition including a defined keyword, initially contained in the link definition file;
generating a display language output file based on the link definition file, said display language output file including:
a function definition including code for opening a pop-up window to display content derived from a display language file specified by an identified parameter; and
a display language code corresponding to the pop-up link definition and including a call to said function with said pop-up content file name as the identified parameter.

83. The method of claim 82 wherein:
said multiplicity of computer mark-up languages is selectable from an SGML format and an XML format;
said display language content file is an HTML content file;
said display language output file is an HTML language output file;
said function definition is a JavaScript function definition;
said display language file is an HTML file; and
said a display language code is HTML code.

84. The method of claim 71 further including the steps of, after accepting the set of definition files:
generating a first intermediate display language code file based on the content definition file and a second intermediate display language code file based on the link definition file;
passing the pop-up link definition from the link definition file to the second intermediate display language code file;
wherein the step of generating an display language code content file comprises the step of accepting the first intermediate display language code file as input to generate the display language code content file, and the step of generating an display language code output file comprises the step of accepting the second intermediate display language code file as input and processing that file to generate the display language code output file.

85. The method of claim 84 in which the step of identifying a pop-up link definition including a defined keyword comprises the step of scanning the second intermediate display language code file to locate the defined keyword.
